(19) United States
(12) Patent Application Publication
(10) Pub. No.: US 2005/0262530 A1
(43) Pub. Date: Nov. 24, 2005

(54) Systems and methods for multimedia communication

(75) Inventors: Johannes Ruetschi, Boca Raton, FL (US); Leroy Edwin Gilbert, Wellington, FL (US)

Correspondence Address: Elsa Keller;Siemens Corporation, Intellectual Property Department, 170 Wood Avenue South, Iselin, NJ, 08830, US

(73) Assignee: Siemens Information and Communication Networks, Inc.

(21) Appl. No.: 10/852,746

(22) Filed: May 24, 2004

(51) Int. Cl. H04N 7/173; G06F 17/00; H04N 7/025

(52) U.S. Cl. 725/35; 725/34; 725/46

(57) ABSTRACT

Systems and methods that allow users in predefined communications groups to selectively control and manage the transfer of multimedia information across a wire or wireless network by allowing a group member to record multimedia content and transmit such content to a distribution server are provided. The present invention may also include a user interface for use with the multimedia messaging system that automatically notifies group members of new member multimedia content.

### BACKGROUND OF THE INVENTION

Over the last decade, there has been an enormous increase in demand for new and better means of communicating and transferring data between consumers over communication networks. The Internet has played an integral role in satisfying this demand and its development has spawned many new modes of communicating and sharing data. For example, some of these new modes include the development of e-mail, chat platforms, instant messaging, and video messaging. During the Internet's early stages, consumers could only access the Internet and these new forms of digital content from a computer that was hardwired to the Internet. However, recently there has been a shift in consumer demand toward wireless communication and data sharing. Consumers want access to all of the above-mentioned forms of communication and data sharing not only while they are at their desks in a hardwired environment, but also in the mobile environment.

In addition to the problem of providing a wireless device with which consumers can communicate using these Internet-type modes of communication, there is also the problem of determining what information to provide. The Internet has quickly become one of the world's largest sources of knowledge and information. The large size and scope of the Internet and other information networks often makes it difficult to find relevant information in a reasonable amount of time. The difficulty in obtaining relevant information from the Internet and other information networks in a timely fashion has given rise to the development of a variety of products and services which locate and sift through large volumes of data in an effort to retrieve and disseminate targeted information that is relevant to particular consumers. For example, consumers can subscribe to certain services that locate and periodically broadcast specified information to their subscribers. This technology is often referred to as “push” technology, in that the information, or digital content, is pushed from the information provider to the subscriber.

The digital content retrieved from push technology is sent by service providers to their subscribers and controlled solely by the service provider, with virtually no input or control from the subscriber (other than the subscriber's initial profile information). Such systems are not designed for ongoing interaction between subscribers and the service provider. Although such systems can provide periodic broadcasts of digital content or information, such as the transmission of e-mail, news, or other information, they are not designed to provide subscriber-to-subscriber communications nor are they designed to convey subscriber defined multimedia content. Moreover, instant messaging systems, such as the Instant Messenger™ service provided by America Online™, which allows basic text messaging between a predefined group of users (often referred to as a “buddy list”), does not allow participants to upload to or share/control multimedia content from a central location. In addition, such systems do not allow the users to personalize or define their own multimedia content to share with other users nor do they provide any mechanisms for managing such content including acquiring, queuing, scheduling, transmitting, editing, and identifying new or unviewed content.

Therefore, what is needed are systems and methods that allow participants to define, manage, edit, and/or control multimedia content on their communication devices, where such content can be shared across a network (either wireless, hardwired, or any suitable combination thereof).

Accordingly, in view of the foregoing deficiencies, it would be desirable to provide improved systems and methods for sharing and controlling the transfer of multimedia information across a network.

It would also be desirable to provide systems and methods that allow users to selectively define, control, and manage the transfer of multimedia information across a hardwired network, a wireless network, or any suitable combination thereof.

### SUMMARY OF THE INVENTION

It is therefore an object of the present invention to provide improved systems and methods for real or quasi real time collaboration involving multimedia content across a network.

It is another object of the present invention to provide improved systems and methods for sharing and controlling the transfer of multimedia information across a network.

It is a further object of the present invention to provide systems and methods that allow users to selectively define, control, and manage the transfer of multimedia information across a network.

It is also an object of the present invention to provide systems and methods that allow users to selectively control and manage the transfer of multimedia information across a wireless network.

These and other objects of the invention are accomplished by providing systems and methods that allow users in predefined communications groups to selectively control and manage the transfer of multimedia information across a wireless network by allowing a group member to record multimedia content and transmit such content to a distribution server. Either during or after transmitting the multimedia content to the distribution server, the distribution server may automatically notify other group users of the presence of the transmitted multimedia content. When notified, the other group members may request the transmitted content from the distribution server.

In one embodiment of the present invention, the user publishing content may stream data to the distribution server which in turn may notify the users in the current collaboration session of the availability of such content before transmission is complete. For example, a user making a very long statement while pressing the record button on his client would like other users to hear the message with minimal delay. Thus, as soon as the minimal buffering required for clean multimedia transmission is reached, the data may be available to the other users in the collaboration session. A preferred implementation is to have the multimedia distribution server act as a “Presence User Agent” as defined in RFC 2778. The users involved in the collaboration sessions would use a client that can act as “Watcher User Agent” and may thus be notified of the availability of new content.

One aspect of the present invention may also include a user interface for use with the multimedia messaging system that automatically notifies group members of new member multimedia content. One embodiment of such a user interface may include a display section for displaying downloaded multimedia content, a clip indicator that lists the available multimedia clips posted by other group members, a status indicator indicative of the status of a member with respect to the multimedia content, and a record button that allows a member to record and post multimedia content to a database for selective viewing by other group members.

### BRIEF DESCRIPTION OF THE DRAWINGS

The above and other objects and advantages of the present invention will be apparent upon consideration of the following detailed description, taken in conjunction with the accompanying drawings, in which like reference numbers refer, to like parts throughout, and in which:

FIG. 1 is a block diagram illustrating the architecture of a messaging and content distribution system in accordance with one embodiment of the present invention.

FIG. 2 is a more detailed block diagram illustrating a portion of the architecture of one embodiment of a multimedia content distribution system shown in FIG. 1.

FIG. 3 is an illustrative example of a user interface suitable for use with the system of FIGS. 1 and 2 in accordance with one embodiment of the present invention.

FIG. 4 is a flow chart illustrating some of the steps involved in defining, controlling, and managing the transfer of multimedia information across a network in accordance with one embodiment of the present invention.

### DETAILED DESCRIPTION OF THE INVENTION

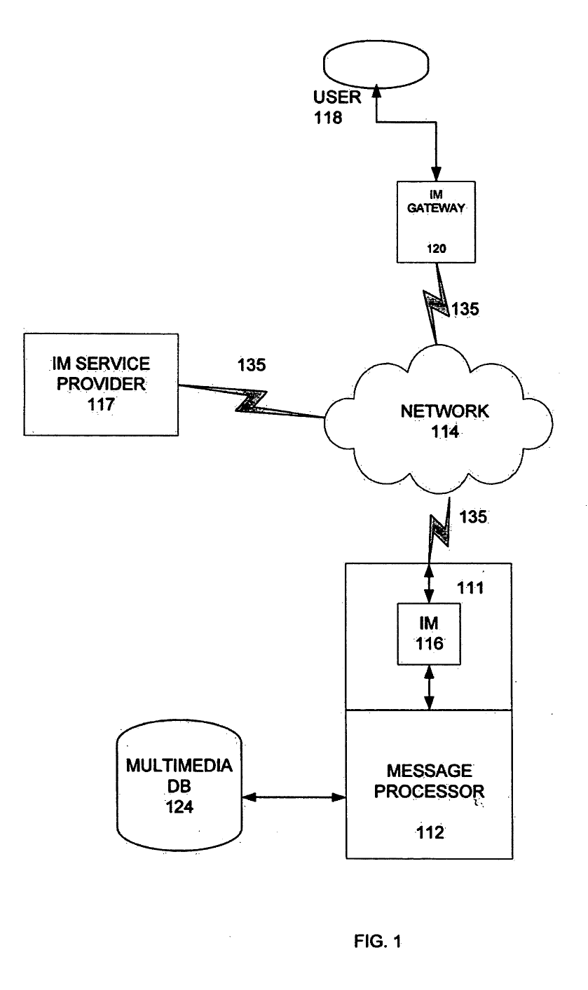

FIG. 1 shows a generalized block diagram of system 100 for interactively sharing multimedia content by and between a group of remotely located users 118. The system may include a message router 111 that may include message processor 112 (alternatively processor 112 may be connected to but located separately from router 111). Processor 112 may be coupled to data network 114 and, in operation, processor 112 may be associated with instant messaging service provider 117 through an appropriate instant messaging application or gateway 116. A user from group 118 is preferably connected to network 114 and instant messenger service provider 117 through instant messaging gateway 120. Instant messaging gateway 120 is typically provided by an instant messenger service provider to which the user has subscribed and provides access to the instant messaging system after the user has logged on. Instant messaging application 116 and Instant messaging gateway 120 are typically configured to enable access to the appropriate or desired instant messaging service providers.

Although not explicitly shown in FIG. 1, users 118 may be equipped with any suitable type of hardwired or wireless communication device that provides instant messaging services. For example, users 118 may be equipped with a communication device such as a personal digital assistant (PDA), or a handheld, desktop, or laptop computer connected to the Internet through any type of suitable connection such as a cable or wireless modem, a WiFi connection (e.g., an 802.11 compliant connection), or a high latency data network (e.g., GPRS) found on a wireless telephone, pager, or any other suitable wire or wireless computer.

Furthermore, communication links 135 depicted by the arrows in FIG. 1, may be any hardwired or a wireless communication link suitable for use with a particular application. For example, for hardwired applications, communication links 135 may be a serial port, a parallel port, a universal serial bus (USB), RS232, GPIB, etc.; a modem (e.g., any suitable analog or digital modem including cable modem, cellular modem, etc.), a network interface link (e.g., Ethernet links, token ring links, etc.), or any other suitable hardwired Internet or network communication links. For wireless applications, communication links 135 may be cellular telephone links, wireless Internet links, WiFi links, optical or infrared links, etc. or any other suitable wireless Internet or network communications links.

To provide instant messaging communication between message processor 112 and a group of users, some of which may subscribe to different instant messaging providers, it may be necessary for message processor 112 to connect to a number of different instant messenger service providers 117 through different gateways 116 or via a single instant messaging protocol gateway 116 with several I/O processing routines to address situations where various messaging service providers do not share a common data protocol (not shown).

In the instant messaging environment depicted in FIG. 1, each user 118 is typically provided with a unique identification name (“screen name”) that is included as part of a message sent from the user to a designated destination. To direct a request for previously uploaded multimedia content to processor 112, a user, after logging on to an instant message service, sends an instant message through service 117. Service 117 directs the message to database 124 through processor 112 to obtain the desired multimedia content. The availability of multimedia content may be determined from the presence server hosted by instant message service 117. The multimedia content may also be accessed directly by a user's client application in a multimedia database via a streaming, or real time transport protocol.

Various types of information may be sent and received during the message interaction that can be stored for later use in multimedia database 124. Database 124 may be, at least in part, any suitable multimedia database or server for receiving, storing, and transmitting multimedia content at a user's request. Such content may be received and/or transmitted in any suitable real-time or quasi-real-time transmission protocol such as any streaming protocol commonly used in connection with conventional media players such as Windows Media Player, Real Media Player, or Quick Time.

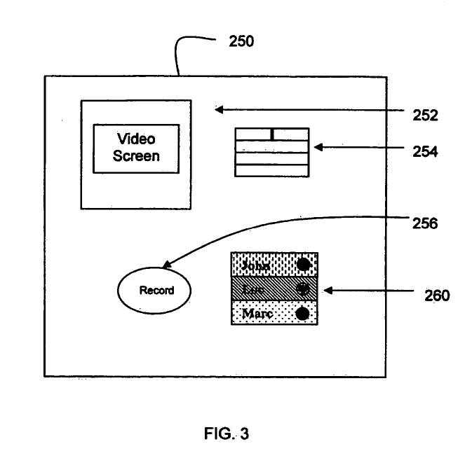

As described in more detail below, database 124 may contain multimedia clips that include audio and/or video information that a user may post to database 124 to selectively share with other group members. For example, a user may record and upload certain multimedia content acquired or retrieved with a personal communication device that the user desires to share with other group members. This content may be sent to and stored in database 124 on behalf of the user. In response to receiving such content, system 100, and specifically database 124 and message processor 112, may provide an audio and/or visual indication to the communication device of other group members such that the other group members are aware that such content is available from a particular user (shown in FIG. 3). In some embodiments, system 100 may allow the user to selectively post multimedia content to database 124 such that the multimedia content is made available to some, all, or none of the group members (e.g., by selectively providing the corresponding audio and/or visual content indicator only to authorized group members).

In operation, a user may post certain multimedia content to database 124 for selectively sharing within a group of users. Group members, notified of the availability of such content by system 100, may then select and download the content for viewing, thus allowing the group members to communicate and share multimedia messages with one another rather than just by mere text messages.

It should be understood that the present invention is suitable for use in real-time or near-real-time streaming applications such as Real-time Streaming Protocol (“RTSP”) or any other communications protocol that may be suitable for multi-user gaming applications, or near real-time video communications. In other embodiments, system 100 may also employ low speed or low bandwidth telecommunications protocols in order to reduce or minimize the necessary capacity of system 100. In these embodiments system 100 may transmit single or still video frames optionally followed by small audio clips. This may be desirable in areas with limited interest in multimedia messaging or in situations where reduced service levels are necessitated by network malfunctions or outages.

Another aspect of the present invention involves customization of multimedia content. A user, for example, may wish to playback, edit and/or customize recorded multimedia content (through the user's communication device) before making it available to other group members. This may be accomplished by allowing a user to post content to database 124 and then to invoke certain known editing and customization programs that may be stored on the user's communication device, on system 100, or at any other suitable location. Customization of recorded content may include adding, deleting, and/or changing any aspect of the audio and/or video in the recorded clip. After the content is deemed satisfactory, the user may then post that content to database 124. The user may grant access to other group members (before or after posting).

Some embodiments of system 100 may have uploading and/or downloading restrictions depending on the system's data transfer characteristics. In cases where the data rate is poor, users may be prevented from uploading and downloading content concurrently. Also, in some embodiments, when a user is recording a message directly to database 124 (without any substantial storage or caching on the user's communication device), the download link may be disabled or unavailable. This disabled status may be made known to the other group members so that they are aware that: 1) new content is being uploaded by that member, 2) that member is not currently downloading or viewing other streaming content, or 3) the quality of that member's communication link is poor.

Another aspect of the present invention deals with managing the stored multimedia clips associated with each group member. In the preferred embodiment, system 100 stores the multimedia clips associated with each group member in database 124 and presents them to group members as clip indicators chronologically (i.e., the oldest unviewed content first). Other illustrative alternative methods may include providing only the most recent content, providing content in a reverse chronological arrangement, providing content in an alphabetical arrangement (e.g., where the user or the system names the uploaded content). One skilled in the art will appreciate that the above methods for arranging content are merely illustrative examples and that any other suitable method for providing content may be used. In addition, system 100 may serialize the uploading of new content to avoid overlapping input from group participants.

Other management functions performed by system 100 may include managing the amount of memory allocated to each user and informing each user of the amount of remaining space available for uploading new content. This might also include such tasks as providing warnings to the user as the user approaches his allotted memory limit and periodically prompting users to delete old or seldom used content. System 100, and particularly database 124 and message processor 112, also preferably perform all queuing and scheduling tasks associated with user requests such as automatically pushing clip indicators to selected group members and uploading and storing user content as well as other normal data management functions associated with servers and databases.

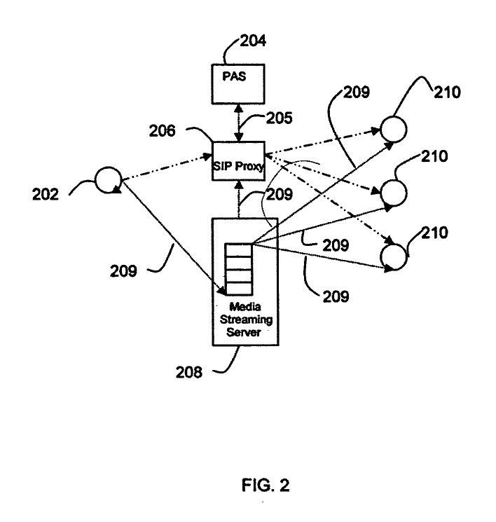

FIG. 2 shows a more detailed block diagram of portions of the multimedia communications system shown in FIG. 1. More specifically, in the particular embodiment shown in FIG. 2, database 124 and message processor 112 may include PAS 204 (e.g., presence availability service (or presence service) as defined in RFC2778), SIP proxy 206 (e.g., SIP components may interface with PAS 204 using SUBSCRIBE/NOTIFY as defined in RFC3265. SIP proxy 206 may be used as defined in RFC 3261.), and multimedia streaming server 208. A user may upload multimedia content using this embodiment as follows:

A user at endpoint 202 records and uploads a multimedia clip from a communications device to server 208 through an RTSP link 209. Simultaneously, the status of this participant (listening, idle, or recording/uploading) is provided to PAS 204 via SIP proxy 206 and SIP/SIMPLE communications link 205. After the clip has been uploaded, its availability on multimedia server 208 is published to PAS 204 (it should also be noted that the availability of a clip may be published as soon as streaming of the clip to server 208 is started and appropriate buffering has been completed). In turn, PAS 204, via SIP Proxy 206 notifies other group participants 210 (i.e., other group members) of the user status located at endpoint 202. Such notification may include updating a member status indicator present on the communication device of the other group participants.

Participants 210 may request available multimedia clips from server 208 by clicking on or selecting an icon or virtual button on member status indicator 260 (shown in FIG. 3). Selecting this button may cause server 208 to retrieve a requested clip and stream it down to the requesting group participant over RTSP link 209. Participants may also continuously stream content as long as content is available on server 208. Sequencing/arranging clips into one or more media streams may be accomplished on server 208 or at any other suitable location in system 100, thus, providing the same experience to all members in a real time or quasi real time collaboration. In some embodiments, while downloading content system 100 may change that member's status indicator from idle to downloading. This may be accomplished, for example, by changing the color of an icon or by deactivating an icon or virtual button associated with that user's status.

FIG. 3 is an illustrative example of a user interface 250 that may be displayed on a group member's communication device in accordance with one embodiment of the present invention. As shown, user interface 250 may include a video output section 252, a clip indicator 254, a member status indicator 260, and a multimedia record button 256. In operation, a user may browse available group content by reviewing the files shown in clip indicator 254 that displays the names of the clips currently available from group members. The clip view may also show the composition of the media stream and when users view or listen to available multimedia content the clip view may provide information about the source or author of the content at that point in the stream. A user may view one of those files by clicking on or highlighting a file name within indicator 254. The selected file is then streamed or otherwise downloaded to the user and displayed on video output section 252 for viewing. In some embodiments, indicator 254 may include some control buttons similar to those found on conventional streaming media players that allow the user to adjust the volume or size of the clip or allow the user to fast forward, rewind, pause, or otherwise edit the selected clip.

In addition to downloading content, a user may also record or upload content from interface 250. This may be accomplished by placing a signal acquisition sensor on the user's communication device such as a camera, video sensor, microphone, or other sensing device in proximity to the activity to be recorded (not shown) and pressing record button 256. This records the desired content, converts it to the proper transmission protocol and streams, or otherwise communicates it to multimedia server 208 as described above, where it is subsequently made available to other group members.

In some embodiments, status indicator 260 may be automatically updated to indicate when other members are uploading or downloading content so the other group members are aware of that user's actions with respect to certain content. For example, indicator 260, which may be a list of available group members arranged by name (or any other suitable arrangement), may display what content is being uploaded or downloaded by a particular member. As shown in FIG. 3, member Luc may be downloading or uploading content as indicated by the change in the status button whereas members John and Marc may be idle. Moreover, indicator 260 may display the name and/or history of content being transmitted to or from a particular member (a feature which may be selectively disabled by the member to preserve privacy).

It will be understood that although interface 250 is shown to include certain feature fields with certain associated functions, this arrangement is merely illustrative and the feature fields and/or associated functions may be changed and/or modified to meet specific needs. For example, interface 250 may include various multimedia editing functions such as means for adding text, audio, and/or video to a multimedia clip. Other features may include the ability to adjust frame size and speed or any other suitable multimedia editing function.

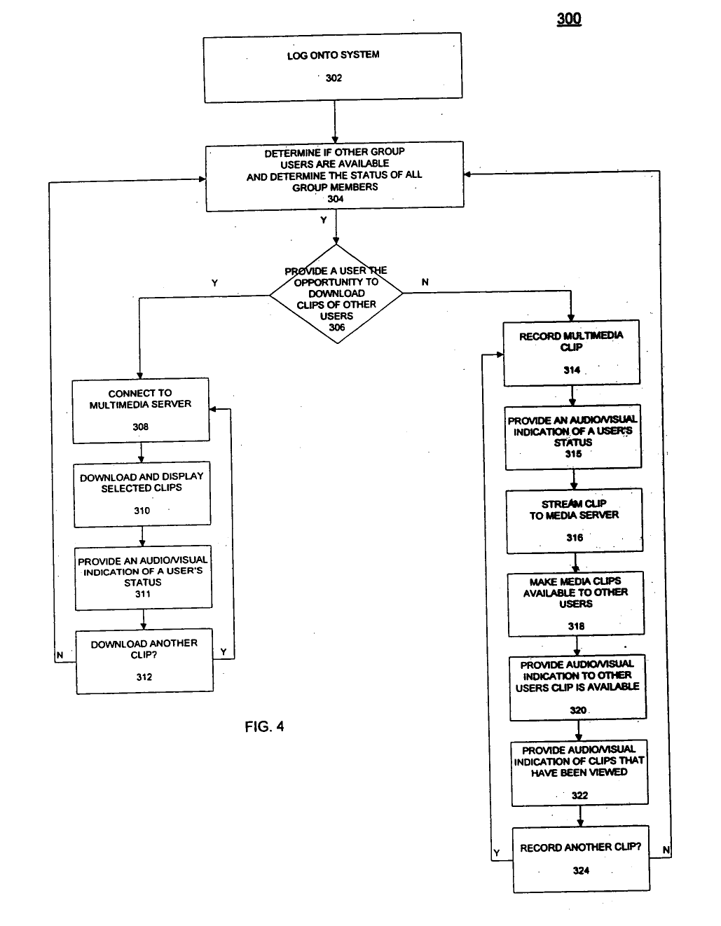

Some of the steps involved in the interactive multimedia communication method of the present invention are illustrated in flow chart 300 shown in FIG. 4. and are described as follows: At step 302, a user logs onto a system or enters a specific network or Internet location that allows others in the user's group to know that a particular user has joined the session or is now online. This may be accomplished by merely turning on a communications device or by actively entering a specific chat room or other designated group location used to announce a user's availability. At step 304, message processor 112 and database 124 note the log on of the new user, determine if other members or participants of that group are available, and determine the status of all members or participants of the group. If so, system 100 transmits a member status indicator to the new user indicative of the other user's presence, their multimedia status (e.g., uploading. downloading or idle), and whether there is any content associated with any of the present users.

At step 306, assuming other participants are online or if other users have previously uploaded new content, the user is provided with the option of downloading multimedia content associated with the users at step 304. If the user chooses to download content, the user may select specific content by selecting the name, icon, or like indicator of a certain participant from the member status indicator displayed on the screen of the user's communications device. Next, at step 308, system 100 connects the communication device to database 124 through message processor 112, and the selected content is streamed or otherwise transferred to the user's communication device at step 310. In some embodiments, while the user is receiving content, system 100 changes that member status indicator from idle to downloading, as shown in step 311. This may be done, for example, by changing the color of an icon or by deactivating an icon or button associated with that user's status. After the requested content is downloaded, the user may download other content by returning to step 308. The user may choose to exit, upload content, or merely listen at this point by returning to step 304. At step 312 the user may be prompted to download another available clip.

A user may choose to upload content at step 306 by selecting the multimedia record button 256 shown in FIG. 3. At step 314, the user's communication device will record, acquire, or otherwise upload previously stored multimedia content to database 124 according to streaming or other applicable data transfer protocols. In some embodiments, while the user is uploading content, system 100 changes that member status indicator from idle to uploading, as shown in step 315. Also, during the above steps, the user's communication device may partially or fully record the multimedia clip before transmitting it to database 124. This may depend on clip size or type, the capacity of the user's communication device, and/or the quality and bandwidth of the communication link involved. If this is the case, the acquired clip is then streamed to database 124 at step 316; otherwise this step may be skipped. For example, a user may desire to skip step 314 by simultaneously acquiring and streaming a clip to database 124 via the user's handheld device (i.e., without prerecording the clip in the memory of the user's device).

Next at step 318, system 100 makes the user's uploaded multimedia clips available to other group members. At step 320, through the SIP proxy shown in FIG. 2, system 100 may notify the group members of the newly uploaded and available content by changing a characteristic of the status icon such as its color, size, etc. Also, in some embodiments, while the user is receiving content, system 100 may change that member status indicator from idle to uploading. This may be done, for example, by changing the color of an icon or by deactivating an icon or button associated with that user status. In some embodiments the user's handheld device and multimedia database 124 may coordinate with each other to ensure the user's recorded clip has been completely and/or properly uploaded to multimedia database 124 (e.g., parity checks, check sums, CRC, etc.). After the requested content is uploaded, the user may upload other content by returning to step 314. The user may choose to exit, upload content, or merely listen at this point by returning to step 304.

At step 322, once multimedia content has been posted to database 124 (shown in FIG. 1), user interface 250 may provide an indication that one or more group members have viewed such content. In one embodiment, user interface 250 may provide a history table associated with a particular user's uploaded content so that the user may determine which other group members have downloaded his content.

It will be understood that these steps are merely illustrative and are not meant to be comprehensive or necessarily performed in the order shown. For example, additional steps may be required if it is desired to review and edit a clip before or after it is uploaded at step 316. This may be accomplished while the clip is resident in the user's communication device before it is uploaded or after it is stored in database 124. Furthermore, in some embodiments, uploaded files may be converted to a format other than the native format in which it was recorded, which may require additional conversion steps not shown. Also, at step 316 or elsewhere, a user may name or revise the name of a currently or previously uploaded file. At step 324 the user may be prompted to record another clip.

Thus, systems and methods that allow message group members to define, manage, and control multimedia content on individual communication devices for transmission across a network are provided. Moreover, it will be understood that the foregoing is only illustrative of the principles of the invention and that various modifications can be made by those skilled in the art without departing from the scope and spirit of the invention. For example, the many aspects of the invention described herein are suitable for use with hardwired, cordless, or wireless communications devices. Accordingly, such embodiments will be recognized as within the scope of the present invention.

Persons skilled in the art will appreciate that the present invention can be practiced by other than the described embodiments, which are presented for purposes of illustration rather than of limitation, and the present invention is limited only by the claims that follow.

1. A method for allowing members in a predefined communications group to share multimedia information, the method comprising:
allowing a group member to receive and record multimedia content;
transmitting multimedia content to a distribution computer;
automatically notifying other group members of the presence of the transmitted multimedia content; and
allowing the other group members to request the transmitted content from the distribution computer.

2. The method of claim 1, wherein the multimedia content includes audio and video data.

3. The method of claim 1, further comprising allowing a group member to customize previously recorded multimedia content.

4. The method of claim 1, further comprising providing at least one of an audio and a video indication to a group member of another group member's status.

5. The method of claim 4, wherein a group members status includes one of uploading multimedia content, downloading multimedia content, and idle.

6. The method of claim 1, further comprising providing one of an audio and a video indication to a group member that new multimedia content is available.

7. The method of claim 1, further comprising allowing a user to selectively transmit multimedia content such that the multimedia content is made available to some, all, or none of the other group members.

8. The method of claim 1, wherein the transmitting the multimedia content to a distribution computer includes using a real-time streaming transmission protocol.

9. The method of claim 1, wherein the transmitting the multimedia content to a distribution computer includes using a quasi-real-time streaming transmission protocol.

10. The method of claim 1, wherein the transmitting the multimedia content to a distribution computer includes using a low speed transmission protocol.

11. The method of claim 1, wherein the transmitting the multimedia content to a distribution computer includes using a low bandwidth transmission protocol.

12. The method of claim 1, further comprising managing the multimedia content associated with each group member.

13. The method of claim 12, wherein the managing multimedia content associated with each group member includes presenting multimedia content to a group member in a predefined format.

14. The method of claim 13, wherein the presenting multimedia content to a group member in a predefined format includes listing the content chronologically.

15. The method of claim 13, wherein the presenting multimedia content to a group member in a predefined format includes listing the content alphabetically.

16. The method of claim 13, wherein the presenting multimedia content to a group member in a predefined format includes listing the content that has been previously viewed by a group member.

17. The method of claim 13, wherein the presenting multimedia content to a group member in a predefined format includes listing the content that has been newly uploaded by a group member.

18. A system that allows members in a predefined communications group to share multimedia information, the system comprising:
an electronic device that includes an interface that allows a group member to receive and record multimedia content;
a bidirectional electronic gateway that communicates with the electronic device and allows the group member to connect to an instant messaging service provider via a communications network;
a multimedia database that stores multimedia content;
a processor that controls the transmission of multimedia content from the multimedia database to a group user;
a processor that controls the reception of multimedia content from a group user to the multimedia database; and
a processor that automatically notifies group users of the presence of transmitted multimedia content

19. The system of claim 18, wherein the multimedia content includes audio and video data.

20. The system of claim 18, further comprising an electronic device that allows a group member to customize previously recorded multimedia content.

21. The system of claim 18, further comprising a processor that provides an audio and a video indication of another group member's status.

22. The system of claim 21, wherein group members status includes one of uploading multimedia content, downloading multimedia content, and idle.

23. The system of claim 18, further comprising a processor that provides one of an audio and a video indication to a group member that new multimedia content is available for viewing.

24. The system of claim 18, further comprising an electronic user device that allows the user to selectively transmit multimedia content such that the multimedia content is made available to some, all, or none of the other group members.

25. The system of claim 18, wherein the transmission of multimedia content from the multimedia database to a group user and the reception of multimedia content from a group user to the multimedia database includes using a real-time streaming transmission protocol.

26. The system of claim 18, wherein the transmission of multimedia content from the multimedia database to a group user and the reception of multimedia content from a group user to the multimedia database includes using a quasi-real-time streaming transmission protocol.

27. The system of claim 18, wherein the transmission of multimedia content from the multimedia database to a group user and the reception of multimedia content from a group user to the multimedia database includes using a low speed transmission protocol.

28. The system of claim 18, wherein the transmission of multimedia content from the multimedia database to a group user and the reception of multimedia content from a group user to the multimedia database includes using a low bandwidth transmission protocol.

29. The system of claim 18, further comprising a processor that manages the multimedia content associated with each group member.

30. The system of claim 29, wherein the processor manages the multimedia content associated with each group member using a predefined format.

31. The system of claim 30, wherein the predefined format is a chronological format.

32. The system of claim 30, wherein the predefined format is a alphabetical format.

33. The system of claim 30, wherein the predefined format is based upon displaying previously viewed content.

34. The system of claim 30, wherein the predefined format is based upon displaying newly uploaded content.

35. A user interface for use with a multimedia messaging system that automatically notifies group members of new member multimedia content, the interface comprising:
a display section for displaying downloaded multimedia content;
a clip indicator that lists the available multimedia clips posted by other group members;
a status indicator indicative of the status of a member with respect to the multimedia content; and
a record button that allows a member to record and post multimedia content to a database for selective viewing by other group members.
